(19) United States
(12) Patent Application Publication
(10) Pub. No.: US 2007/0283803 A1
(43) Pub. Date: Dec. 13, 2007

(54) Bellows arrangement

(75) Inventor: Manfred Moritz, Plochingen (DE)

Correspondence Address: HOFFMANN & BARON, LLP, 6900 JERICHO TURNPIKE, SYOSSET, NY, 11791, US

(73) Assignee: Festo AG & Co

(21) Appl. No.: 11/732,941

(22) Filed: Apr. 5, 2007

(30) Foreign Application Priority Data
Apr. 15, 2006 (DE) 20 2006 006 113.4

(51) Int. Cl. F16J 3/04

(52) U.S. Cl. 92/34; 138/121

(57) ABSTRACT

A bellows arrangement comprises at least one bellows having at least one elastic primary fold structure composed of annular primary folds following each other coaxially in sequence. The annular primary folds each comprise at least one secondary fold structure composed of a plurality of secondary folds distributed along the annular periphery of the primary folds and extending athwart the peripheral direction so that the primary fold structure can be radially widened in the annular waist portions, located between two axially succeeding primary folds by unfolding the secondary folds.

### BACKGROUND OF THE INVENTION

The invention relates to a bellows arrangement comprising at least one bellows having at least one elastic primary fold structure composed of annular primary folds following each other coaxially in sequence.

### THE PRIOR ART

A bellows arrangement disclosed in the German patent publication 103 45 587 A1 is designed in the form of a fluid drive. A bellows having coaxially arranged sequentially following folds defines an internal space which may be supplied with drive fluid. In the waist portions between sequentially following folds ring elements are placed, which are to cause stiffening of the bellows.

A further bellows arrangement of the type initially mentioned is described in the German patent publication 199 53 934 C2. In this case a bellows consisting of metal or plastic is a component of a fluid operated linear drive and may be filled to a greater or lesser extent with a hydraulic liquid in order to cause a servo action.

Finally the German patent publication 101 22 796 B4 describes a bellows arrangement which is designed in the form of a piston and cylinder unit and whose bellows functions as a guard cover of axially variable length.

### SHORT SUMMARY OF THE INVENTION

One object of the invention is to provide a bellows arrangement whose at least one bellows has an optimized deformation behavior.

In order to achieve this and/or other aims appearing from the present specification, claims and drawings there is a provision such that the coaxially succeeding annular folds, termed the primary fold structure respectively each comprise at least one secondary fold structure, which consists of a plurality of secondary folds distributed over the annular extent of the primary folds and extending athwart the peripheral direction so that the primary fold structure is able to be radially expanded in the annular waist portions, located between two annular succeeding primary folds by unfolding the secondary folds.

Accordingly the use of the bellows arrangement involves a radial expansion of the at least one bellows in its waist portions without any substantial material stretch being necessary. The expansion of the primary fold structure takes place in the annular waist portions essentially simply owing to a change in geometrical form and more particularly by bending of the bellows wall so that the material does not oppose a radial expansion with any particular resistance. Accordingly there is a clearly defined deformation, something which favors the use of the bellows in many applications.

The bellows arrangement may for example be an actuator means, at least one bellows of the type described constituting a component of a fluid operated actuator using which axial thrusts may be applied. The bellows may in this case be closed at its two ends respectively by a terminal wall and be connected with at least one control duct serving for the supply and/or removal of an actuating fluid.

The bellows arrangement may also be designed in the form of a fluid pump and more especially an air pump. By alternating axial compression and drawing apart it is possible for the interior space of the bellows to have an alternating suction and displacement action produced in it. Fluid can also be pumped in this manner.

In the case of a further possible design the at least one bellows constitutes a guard cover, which may be termed a guard bellows, for relatively moving parts for example.

Use in connection with artificial respiration is also conceivable.

The bellows arrangement may also be designed as a shock absorber arrangement. At least one bellows is in this case a component of a fluid shock absorber.

In the case of use as a fluid operated actuator the associated bellows arrangement may be both a linear drive means or also a rotary drive means or a pivoting oscillating drive. The at least one bellows may, owing to the particular structure of its folds, be utilized not only with a linear movement but also in a curved configuration.

The bellows arrangement may comprise or consist of a single bellows. On the other hand however a multiple arrangement is possible with several bellows. Such bellows may be arranged both in series or in parallel.

In the case of a further possible application the bellows is a component of a resiliently elastic suction cup. It may for example be employed for handling objects in manufacturing and assembly work.

Furthermore the at least one bellows may constitute a tube compensator for length or angle compensation.

Use a component of a pressure receiver, for example in pneumatic equipment or in heating installations is also possible.

The at least one bellows may furthermore be a component of a collapsible vessel. Its bellows structure in this case renders possible a compact axial folding up of the vessel.

Use as an actuating instrumentality or as a wall of a spray can is a further possible application of the bellows.

Blowing bellows applications are also possible.

Further advantageous developments of the invention are defined in the claims.

In principle the structure could involve an arrangement of secondary folds such that between succeeding secondary folds a fold-free section of the bellows wall is present. However it is regarded as being advantageous to design the secondary fold structure such that the secondary folds are arranged in immediate succession in the peripheral direction of the primary folds.

It is furthermore expedient to adopt a design of the secondary folds such that in the completely unfolded state of the secondary folds the resulting enlarged periphery of the radially outwardly shifted waist portions at least substantially corresponds to the periphery of the apical portions of the primary folds. Accordingly the bellows may always have a substantially tubular form in the completely unfolded of its secondary folds. Such a cylindrical form is particularly stable in the axial direction and furthermore the bellows arrangement is predestined to function an actuator means acting with a thrust force.

In the apical portion of the primary folds it is convenient not to provide for any secondary folds. The apical portions may more especially have a circular outline. Owing to such a configuration there is no unfolding geometry in the apical portions and a radial expansion would only be possible by a stretch of the bellows material. Accordingly the bellows in the apical portions is subject to a greater supporting effect than in the waist portions having secondary folds. The radial extent of the bellows when subjected to internal pressure accordingly takes place preferentially in the portions between the succeeding waist portions so that a clearly defined deformation occurs.

The primary folds have an annular fold limb extending from the apical portions. In the waist portions the mutually facing bellows limbs of the respectively axially succeeding primary folds are joined together, preferably in an integral manner and with a transition between the secondary folds without interruption of the folds.

The secondary fold structure of the individual fold limbs may more particularly be fan-like in design. Starting from the apical portion of the primary folds the fold width preferably diminishes toward the associated waist portion and simultaneously an increasing height of the individual secondary folds.

In the apical portions and in the waist portions of the primary structure there may be an angled or a curved configuration of the bellows material. In this respect it is possible to speak of angled folds or rounded folds. The particular configuration will depend in particular also on the respective purpose of use.

It is convenient for the secondary fold structure of the individual annular fold limbs to be identical in form in conjunction with an identical fold distribution over the annular periphery of a respective fold limb. If then the secondary fold structures of axially succeeding fold limbs are arranged with such a reversed orientation that the front side of the respective one fold structure is opposite to the rear side of the following fold structure, there will be an optimum possibility of axial interengagement of the succeeding secondary fold structures on axial folding up of the bellows.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 shows a preferred first design of the bellows arrangement in accordance with the invention, here in the form of a actuator means in a side view and in the neutral position of the bellows.

FIG. 2 is a cross section taken through the arrangement of FIG. 1 on the section line II-II.

FIG. 3 shows the portion marked III in FIG. 1 on a greater scale.

FIG. 4 is a section taken through a secondary fold structure in an apical portion of a primary fold, taken on the section line IV-IV of FIG. 3.

FIG. 5 represents a section comparable with FIG. 4 and taken on the section line V-V of FIG. 3 in an intermediate area between the apical portion and the waist portion of a primary fold.

FIG. 6 shows a further application of the bellows arrangement in a diagrammatic representation.

### DETAILED ACCOUNT OF WORKING EMBODIMENTS OF THE INVENTION

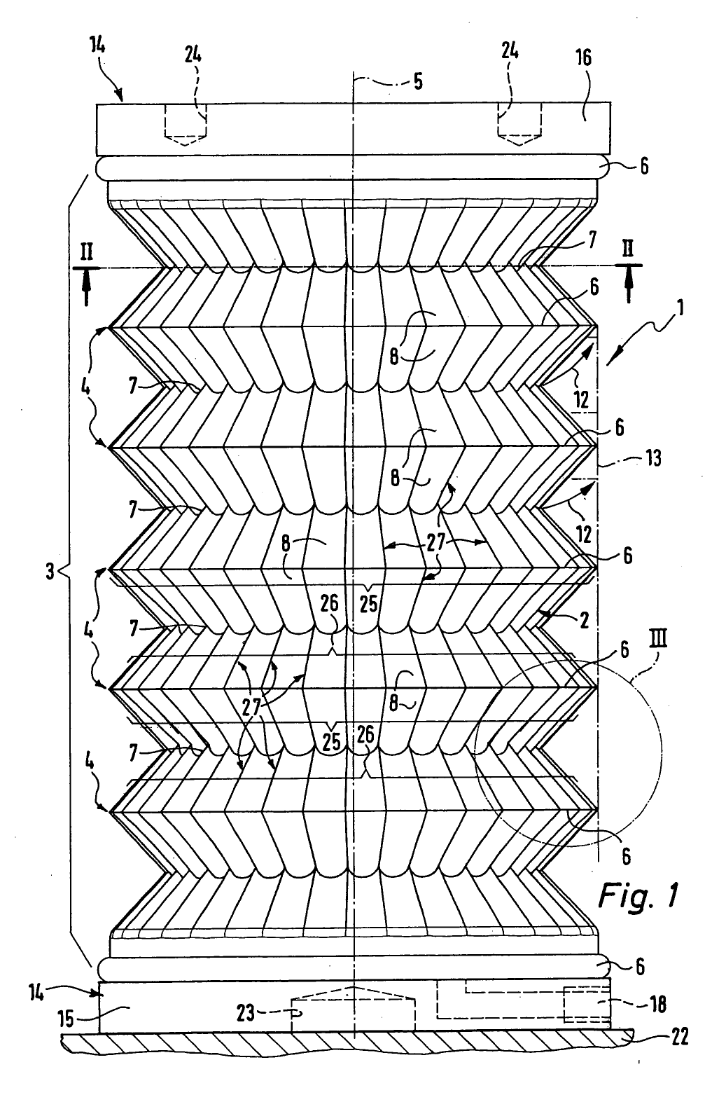

FIG. 1 shows a bellows arrangement generally referenced 1, which possesses a bellows 2, aligned, for example vertically, that is to say an elongated tubular body with a folded peripheral wall.

The bellows 2 possesses elastic properties and consists in particular of plastic material. In this respect it is a question preferably of an elastomeric material. An integral design is more especially economic.

The bellows arrangement 1 could also comprise several bellows, for example in a parallel arrangement and/or in a series arrangement.

The bellows 2 exhibits a primary fold structure 3, which is made up of a plurality of coaxially succeeding annular primary folds 4. Each primary fold has an annular apical portion 6 having a certain diameter in relation to the longitudinal axis 5 of the bellows 2. Axially adjacent primary folds 4 respectively merge with each other at an annular waist portion 7 having a smaller diameter than the apical portion. Between each apical portion 6 and its axially adjacent waist portions there extends an annular fold limb 8. The fold limbs 8 may have an essentially frustoconical outline in the neutral position of the bellows 8.

The primary folds 4 of the working example are essentially in the form of angled folds. In this case in the apical portions 6 and in the waist portions 7 there are angled transitions between the individual fold limbs 8. However more tightly radiused rounded transitions would also be possible. The primary folds 4 could then more particularly be in the form of rounded folds with round transitions both in the apical portion 6 and also in the waist portions 7.

The two terminal primary folds 4 terminating the bellows 2 are in the working embodiment merely in the form of half folds. They possess only one fold limb 8 so that the bellows 2 ends at a respective apical portion 6 of the primary fold structure 3. However as a departure from this one or both of the terminating primary folds 4 could also be complete folds-free.

The neutral position of the bellows 2 illustrated in FIG. 1 is due to the inherent rigidity of the bellows structure in the condition not subjected to external forces. Starting with this neutral position of the bellows 2 to be compressed in the longitudinal, the primary folds 4 being more strongly folded up until in the end the fold limbs 3 of all primary folds 4 abut each other. An axial extension is also possible, the primary folds 4 being drawn apart in accordance with the degree of longitudinal extension.

The axial extension takes place, owing to the preferred configuration of the bellows 2, without radial expansion of the apical portions 6. The material used for longitudinal extension depends on the increase in diameter of the waist portions 7, as is indicated in FIG. 1 at 12 by arrows. The bellows arrangement 1 is so designed that there is a maximum expansion of the waist portions 12 when a tubular form, indicated by its outline in chained lines has come into being, is assumed.

In the case of the actuator of the example the bellows 2 is a component of a fluid power actuator 14. This actuator 14 possesses two terminal walls 15 and 16 between which the bellows 2 extends axially and which are respectively secured to one of the two axial end sections of the bellows 2 with a sealing connection.

The internal space 17 delimited by the bellows 2 and the two terminal walls 15 and 16 communicates with at least one control duct 18, which preferably extends through one of the terminal walls 15 and 16. By way of such duct any desired gaseous medium or hydraulic drive fluid can be supplied or removed. Preferably, compressed air is employed as a drive fluid.

A pressure medium fed into the internal space 17 acts on the inner faces of the two terminal walls 15 and 16 shifting same apart in the direction of the longitudinal axis 5, there then being an elongation of the bellows 2.

In this application as illustrated preferably the first terminal wall 15 having the control duct 18 is fixed stationarily in place, for example on a holder 22, indicated diagrammatically, of a machine. For securing it suitable attachment means are provided at 23.

The opposite second terminal wall 16 is provided with second attachment means 24, on which a component, which is to be shifted, may be secured in a detachable fashion, for example a part of a machine. Owing to the controlled fluid action in the internal space 17 the second terminal wall 16 is shifted either away from the first terminal wall 15 or shifted toward it. The result is a corresponding actuation of the machine part secured to it.

The actuator 14 is more especially so designed that it may assume a retracted position, in which the bellows 2 is compressed to a maximum extent axially. This state is produced either by vacuum acting in the internal space 17 or however by external forces acting by way of the second terminal wall 16 on the bellows 2, for example a weight force of a component to be acted upon. However the bellows 2 may also be so designed that the neutral position in the as manufactured condition already roughly corresponds to the state of maximum axial compression. The fold limbs 8 are then already in contact with each other or are only slightly spaced apart.

The advantageous deformation behavior of the bellows 2 more especially results because the annular primary folds 4 have at least one secondary fold structure 25 and 26, which are orientated along the bellows 2.

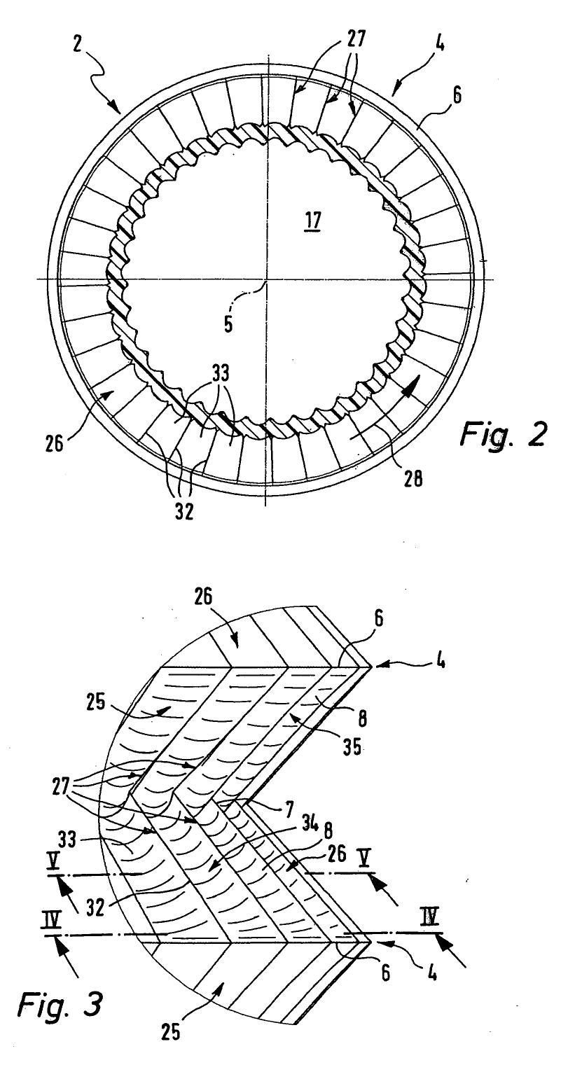

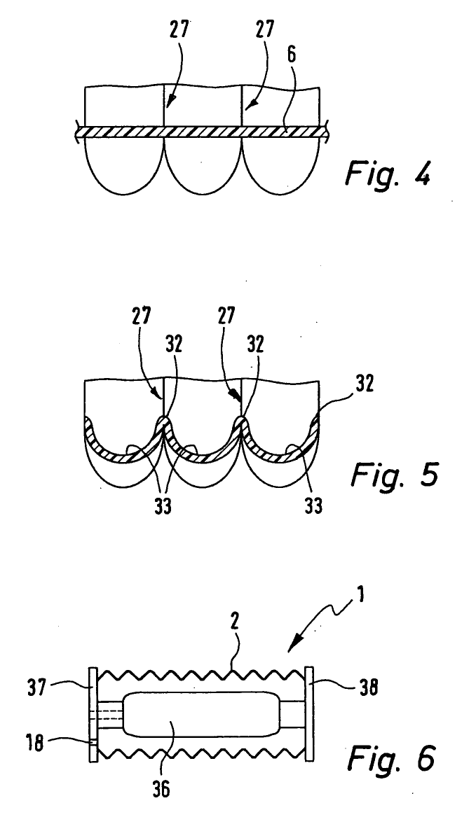

The secondary folds 27 are distributed over the annular periphery of a respective primary fold 4, i. e. arranged in the peripheral direction 28, as indicated by the arrow in FIG. 2, around the longitudinal axis 5 of the bellows 2. In this case the secondary folds 27 respectively extend athwart the direction 28. The secondary folds 27 are preferably arranged in a continuous sequence in the peripheral direction 28 succeeding one another so that they merge without any fold-free intermediate portion directly with each other.

Each fold limb 8 comprises such a secondary fold structure 25 or, respectively, 26. In the annular waist portions 7 the mutually adjoining fold structures 25 and 26 more particularly directly merge with each other so that in the waist portions 7 as well there is a secondary folding.

The apical portions 6 of the primary folds on the other hand are preferably free of secondary folding. As more particularly indicated by FIG. 2, the bellows 2 may have an circular outline in the apical portions 6.

The secondary folds 27 are preferentially aligned radially in relation to the longitudinal axis 5. In the example they have a raised saddle portion 32 and trough portions 33 merging with such saddle portion 32 in the peripheral direction. The saddle portions 32 and the trough portions 33 each have a linear extent which is radial in relation to the longitudinal axis 5, a larger or smaller angle being present in relation to the longitudinal axis 5.

The secondary fold structures 25 and 26 preferably have fan-like configuration as long as the bellows 2 is in the condition which is not axially extended fully. The distance measured in the peripheral direction 28 between succeeding saddle portions 32 is greatest adjacent to the annular apical portion 6 and at a minimum at the waist portion 7. The width of the secondary folds 27 decreases accordingly starting at the annular apical portion 6 toward the waist portion 7. At the same time there is therefore an increase in fold height in this direction.

The design is more particularly such that the length of the material measured between two adjacent saddle portions 32 in the peripheral direction 28, of the secondary fold structures 25 and 26 is constant along the entire length in the secondary folds 27. Accordingly the waist portions 7 can be widened without any substantial stretch of the material radially to reach the same diameter as the apical portions 6.

When therefore the internal space 17 is subjected to the drive fluid, radial expansion of the primary fold structure is possible into the portion (located between the axially succeeding apical portions 6) which results only from the superimposed unfolding of the primary folds 4 and the secondary folds 27 and does not involve stretch of the material.

On the apical portions, which are not included in the secondary fold structures 25 and 26, at this position there is only very little yield. The design is more especially such that during maximum pressure action occurring in the internal space during operation there is no substantial material stretch in the apical portions 6. An additional stiffening effect, for example using stiffening rings embedded in the bellows wall in the apical portions, would be possible. The radial widening is therefore concentrated in the sections, placed between the succeeding apical portions 6, of the bellows 2, such sections being defined by the above mentioned structures 25 and 26. Accordingly the bellows 2 will during actuation tend to unfold to form a stable tubular body.

The different secondary fold structures 25 and 26 preferably have such a structure that in the peripheral direction 28 there is the same distribution of the secondary folds 27 in all secondary fold structures 25 and 26. Accordingly there is a plurality of rows spaced out in the peripheral direction of saddle portions 32 succeeding one another on the one hand in the longitudinal direction of the bellows 2 and on the other hand succeeding trough portions 33. On axially folding up the bellows the saddle portions 32 abut each other and the trough portions 33 also abut one another.

In this respect it is an advantage to have such an orientation that secondary fold structures 25 and 26 succeeding each other in the direction of the longitudinal axis 5 are opposite to each other in pairs at their front sides 34 and their rear sides 35. The front side is that side of the secondary fold structures 25 and 26 at which the saddle portions 32 and the trough portions 33 appear. The rear side 35 is the side opposite thereto.

Owing to this arrangement there is a possibility, during folding up of the bellows 2, of the saddle portions of one respective fold structure fitting axially into the recesses constituted by the rear side of the saddle portions of the following secondary fold structure. In the same fashion the trough portions 33 may fit into each other. The consequence of this is that the bellows 2 in the completely axially folded up state has a small overall height.

The possibilities of use for bellows having a combined primary fold structure 3 and the secondary fold structures 25 and 26 are not limited to the actuator field. Further applications for example include use as an air pump, a liquid pump, a guard bellows, for artificial respiration, as a shock absorber, as a low pressure actuator, as a 90 degree pivotal drive, as a suction cup with a resilient action, a tube compensator for changes in length and angle, as a metering cylinder, as a receiver to allow for expansion, as a space saving collapsible gas cylinder, as a spray can, as a bellows for blowing or as a cover for joysticks.

Furthermore the bellows actuator may also be combined with other types of actuator. It would for example be possible to have a combination with a tension actuator, a coaxial arrangement then being preferred so that in accordance with FIG. 6 a draw action actuator 36 is surrounded by at least one bellows 2. To exert a drawing force the tension actuator and is put into action for exerting a thrust force the bellows 2. The two components 2 and 36 have their aligned end sections engaging one and the same coupling structure 37 and 38. In the case of the drawing actuator it may more particularly be a question of a contracting actuator as is for example described in the patent publication WO 00/61952 A1.

1. A bellows arrangement comprising at least one bellows having at least one elastic primary fold structure composed of annular primary folds following each other coaxially in sequence, wherein the annular primary folds each comprise at least one secondary fold structure composed of a plurality of secondary folds distributed along the annular periphery of the primary folds and extending athwart the peripheral direction so that the primary fold structure can be radially widened in the annular waist portions, located between two axially succeeding primary folds, by unfolding the secondary folds.

2. The bellows arrangement as set forth in claim 1, wherein the secondary folds are respectively arranged directly succeeding one another in the peripheral direction of the primary folds.

3. The bellows arrangement as set forth in claim 1, wherein the secondary fold structure is so designed that in its completely unfolded state the resulting enlarged periphery of the waist portions is at least approximately equal to the periphery of the apical portions of the primary folds.

4. The bellows arrangement as set forth in claim 1, wherein the apical portion of the primary folds lacks secondary folds whereas secondary folding is present in the waist portions

5. The bellows arrangement as set forth in claim 1, wherein the primary folds respectively possess a radially outwardly disposed apical portion and merge with each other in annular waist portions of lesser diameter lying axially between adjacent apical portions, each annular fold limb extending between a apical portion and a waist portion, of the individual primary folds possesses a secondary fold structure and these secondary fold structures directly merge with each other in the waist portions.

6. The bellows arrangement as set forth in claim 5, wherein the secondary fold structures merge with each other in the waist portions with continuous folding.

7. The bellows arrangement as set forth in claim 5, wherein the secondary fold structure of a respective fold limb is fan-like in shape with a fold width decreasing in size starting at the annular apical portion toward the annular waist portion and also with an increasing fold height of the individual secondary folds.

8. The bellows arrangement as set forth in claim 5, wherein the secondary folds of each annular fold limb each have a raised saddle portion and merge together by way of a recessed trough portion, the secondary folds of the fold limbs, connected together by way of a waist portion, being arranged in the peripheral direction of the fold limbs with an even distribution and facing each other with on the one hand the front side and on the other hand the rear side of their fold structures so that the secondary fold structures on each side may nest into each other on axial folding up of the primary fold structure.

9. The bellows arrangement as set forth in claim 8, wherein the secondary fold structures are arranged in the longitudinal direction of the bellows with alternating directions of their front sides and their rear sides.

10. The bellows arrangement as set forth in claim 5, wherein the apical portions of the primary folds have a circular outline.

11. The bellows arrangement as set forth in claim 1, wherein the at least one bellows is a single piece hollow body.

12. The bellows arrangement as set forth in claim 1, wherein the at least one bellows consists of a material with rubber-like elastic properties.

13. The bellows arrangement as set forth in claim 1, wherein the at least one bellows is a component of a fluid power operated actuator, which has at least one control duct communicating with the internal space of the bellows for the supply and/or removal of a drive fluid and which is able to be employed as an axially thrusting actuator.

14. The bellows arrangement as set forth in claim 13, wherein the bellows is closed at its two ends by a terminal wall, respectively.

15. The bellows arrangement as set forth in claim 13, wherein the bellows surrounds a traction actuator.

16. The bellows arrangement as set forth in claim 15, wherein the traction actuator is a contraction drive.

17. The bellows arrangement as set forth in claim 1, wherein at least one bellows is a component of a fluid pump.

18. The bellows arrangement as set forth in claim 1, wherein at least one bellows constitutes a protective cover.

19. The bellows arrangement as set forth in claim 1, wherein at least one bellows is a component of a shock absorber.

20. The bellows arrangement as set forth in claim 1, wherein at least one bellows is a component of a resilient suction cup.

21. The bellows arrangement as set forth in claim 1, wherein at least one bellows constitutes a tube compensator for length and/or angle changes.

22. The bellows arrangement as set forth in claim 1, wherein at least one bellows is a component of a collapsible vessel.
